(19) United States
(12) Patent Application Publication
(10) Pub. No.: US 2023/0171009 A1
(43) Pub. Date: Jun. 1, 2023

(54) OVER-THE-AIR (OTA) CHANNEL EQUALIZATION IN MILLIMETER WAVE TESTING

(71) Applicant: QUALCOMM Incorporated, San Diego, CA (US)

(72) Inventors: Bin HAN, Beijing (CN); Valentin Alexandru GHEORGHIU, Yokohama-shi (JP); Lu GAO, Beijing (CN); Yiqing CAO, Beijing (CN)

(21) Appl. No.: 17/754,815

(22) PCT Filed: Nov. 6, 2019
(86) PCT No.: PCT/CN2019/116000

§ 371 Date: Apr. 13, 2022

(30) Foreign Application Priority Data
Sep. 7, 2020 (TW) 109130557

(51) Int. Cl. H04B 17/318; H04L 5/00; H04W 24/10

(52) U.S. Cl. CPC H04B 17/318; H04L 5/0051; H04W 24/10

(57) ABSTRACT

Wireless communications systems and methods related to over-the-air (OTA) channel equalization in millimeter wave mmWave) testing are provided. An apparatus transmits, to a wireless communication device positioned within an over-the-air (OTA) space, one or more reference signals. The apparatus receives, from the wireless communication device, channel state information in response to the one or more reference signals. The apparatus determines a channel estimate for the OTA space based on the received channel state information. The apparatus transmits, to the wireless communication device, a communication signal based on a reference channel and the channel estimate for the OTA space.

### CROSS-REFERENCE TO RELATED APPLICATIONS

The present application is a 35 U.S.C. 371 National Phase entry of Patent Cooperation Treaty (PCT) Application No. PCT/CN2019/116000, filed Nov. 6, 2019. The present application further claims priority to Taiwanese Application No. 109130557, filed Sep. 7, 2020. The aforementioned applications are hereby expressly incorporated herein by reference in their entireties.

### TECHNICAL FIELD

This application relates to wireless communication systems, and more particularly to over-the-air (OTA) channel equalization in millimeter wave (mmWave) testing.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mmWave bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

Prior to NR, performance tests for wireless communication devices are performed using conducted test methods, where radio transmitters and radio receivers are directly connected using radio frequency (RF) cables and antenna connectors. However, conducted antenna connectors are not available for mmWave wireless communication devices due to the high frequencies and the need for directional testing. Thus, OTA testing may be applied to testing of wireless communication devices operating at mmWave frequencies.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication, including transmitting, by an apparatus to a wireless communication device positioned within an over-the-air (OTA) space, one or more reference signals; receiving, by the apparatus from the wireless communication device, channel state information in response to the one or more reference signals; determining, by the apparatus, a channel estimate for the OTA space based on the received channel state information; and transmitting, by the apparatus to the wireless communication device, a communication signal based on a reference channel and the channel estimate for the OTA space.

In an additional aspect of the disclosure, an apparatus including a transceiver configured to transmit, to a wireless communication device positioned within an over-the-air (OTA) space, one or more reference signals; receive, from the wireless communication device, channel state information in response to the one or more reference signals; and transmit, to the wireless communication device, a communication signal based on a reference channel and a channel estimate for the OTA space; and a processor configured to determine the channel estimate for the OTA space based on the received channel state information.

In an additional aspect of the disclosure, a non-transitory computer-readable medium having program code recorded thereon, the program code including code for causing an apparatus to transmit, to a wireless communication device positioned within an over-the-air (OTA) space, one or more reference signals; code for causing the apparatus to receive, from the wireless communication device, channel state information in response to the one or more reference signals; and code for causing the apparatus to determine a channel estimate for the OTA space based on the received channel state information; and code for causing the apparatus to transmit, to the wireless communication device, a communication signal based on a reference channel and the channel estimate for the OTA space.

In an additional aspect of the disclosure, an apparatus including means for transmitting, to a wireless communication device positioned within an over-the-air (OTA) space, one or more reference signals; means for receiving, from the wireless communication device, channel state information in response to the one or more reference signals; and means for determining a channel estimate for the OTA space based on the received channel state information; and means for transmitting, to the wireless communication device, a communication signal based on a reference channel and the channel estimate for the OTA space.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates a millimeter wave (mmWave) wireless communication device test setup according to some aspects of the present disclosure.

FIG. 4 is a block diagram of a user equipment (UE) according to some aspects of the present disclosure.

FIG. 5 is a block diagram of an exemplary network equipment according to some aspects of the present disclosure.

FIG. 6 is a signaling diagram of a mmWave wireless communication device test method according to some aspects of the present disclosure.

FIG. 7 is a flow diagram of a mmWave wireless communication device test method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

NR may specify various test cases to test UEs for conformances and/or performance. Traditional conducted RF test methods use a well-behaved, predictable transmission line, for example, an RF cable and an antenna connector between the test equipment and the device under test (DUT). For mmWave testing, an OTA connection is used in place of the RF cable and antenna connector. To ensure a well-controlled RF environment for OTA testing, the OTA connection may be managed inside of an anechoic chamber. However, the OTA connection may introduce quasi-static channel characteristics into the test signal transmission path, causing test measurements to be inaccurate and/or degraded.

The present application describes mechanisms for OTA channel equalization in mmWave testing. For instance, a test equipment may emulate operations of a base station (BS) to transmit one or more reference signals, such as synchronization signal blocks (SSBs) including synchronization signals (e.g., secondary synchronization signals (SSSs)) and channel state information-reference signals (CSI-RSs), to a user equipment (UE) positioned within an OTA test chamber. The UE may report channel state information based on the one or more reference signals. The channel state information may include reference signal received power per branch (RSRPBs) and reference signal antenna relative phase (RSARPs). An RSRPB may refer to a per-polarization received signal power. An RSARP may refer to a relative phase between two antenna ports (e.g., between a first receive antenna port and a second receive antenna port) at the UE. The test equipment may determine a channel response for the OTA connection or OTA space between the UE and the test equipment based on the RSRPBs and RSARPs reported by the UE. The test equipment may determine a channel equalizer to equalize the channel effects of the OTA connection based on the estimated OTA channel response. The test equipment may generate a test signal and apply the equalizer to the test signal prior to transmission to the UE for testing. In other words, the equalizer pre-compensates the test signal so that the test signal received at the UE does not include the channel characteristics of the OTA channel or at least include a minimal amount of distortion from the OTA channel.

Aspects of the present disclosure can provide several benefits. For example, the application of the OTA channel equalization during test signal generation can improve test measurement accuracy (e.g., for UE demodulation testing) with OTA testing. The use of CSI-RSs in addition to the SSSs for channel measurements and reports allow for a more accurate estimation of the OTA channel and in turn a more accurate OTA channel equalizer.

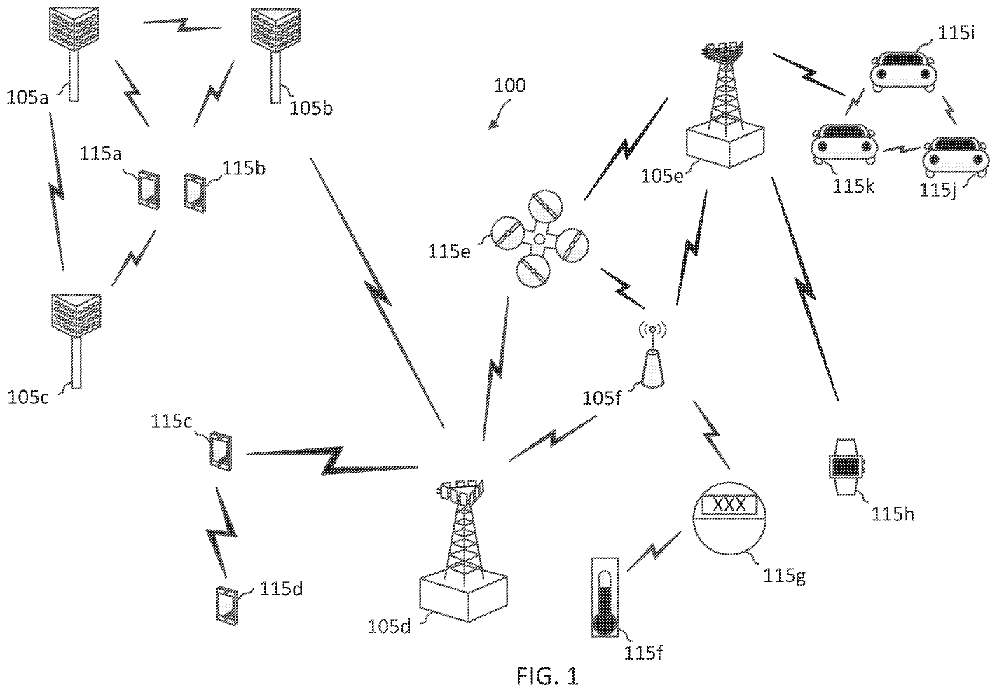

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. ABS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). ABS for a macro cell may be referred to as a macro BS. ABS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

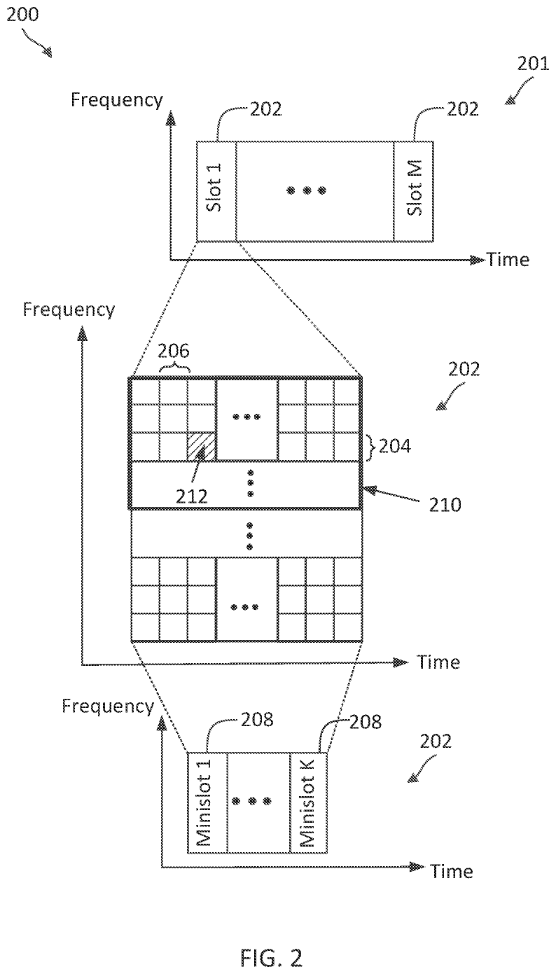

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

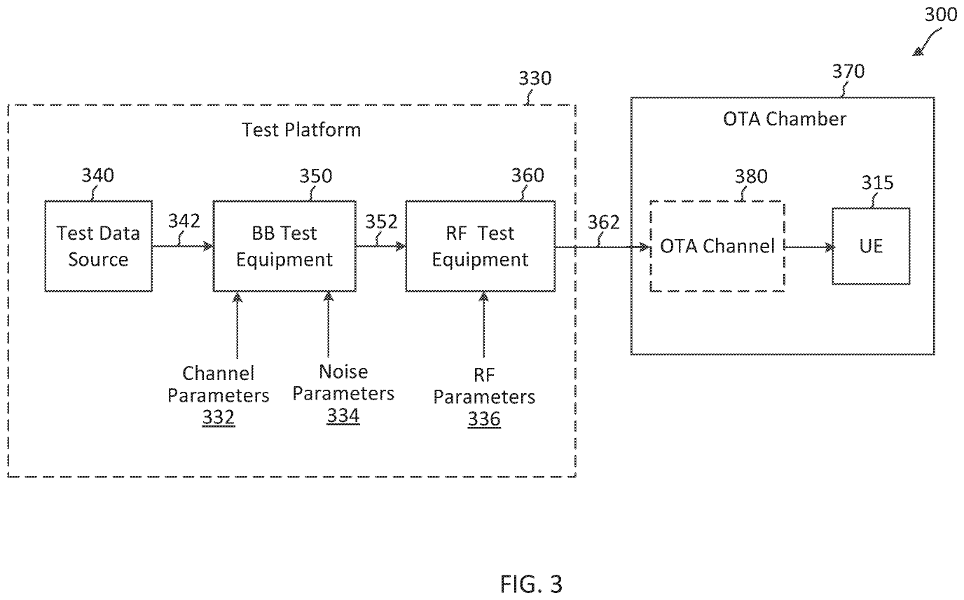

FIG. 3 illustrates a mmWave wireless communication device test system 300 according to some aspects of the present disclosure. The test system 300 may be used to test BSs such as the BSs 105 and/or UEs such as the UEs 115 for performance and/conformance. In particular, the test system 300 may be used to test performances and/or conformances of UEs operating at mmWave frequencies. For instance, the test system 300 may be used for UE baseband (BB) testing, such as demodulation and CSI testing. As shown, the test system 300 includes a test platform 330 communicatively coupled to a OTA chamber 370. The test platform 330 includes a test data source 340, a baseband (BB) test equipment 350, and an RF test equipment 360. The OTA chamber 370 is a physical enclosure, for example, constructed from anechoic material, to provide RF isolation. A UE 315 (e.g., the UEs 115) under test may be placed within the OTA chamber 370 so that the UE 315 may be tested under a controlled environment. The RF test equipment 360 may include power amplifiers (PAs) and antennas (e.g., an array of antenna elements and/or a probe antenna). The UE 315 may include a BB module and an RF module including PAs and antennas. The antennas at the RF test equipment may be referred to as test equipment antennas. The test equipment antennas are communicatively coupled to the UE 315's antennas over a wireless communication link within the OTA chamber 370. For instance, RF signals transmitted by the test equipment antennas are fed into the OTA chamber 370. In some aspects, the UE 315 may be positioned at various orientations or angles with respect to the test equipment antennas depending on the desired test conditions. In some aspects, the test equipment antennas may also be steered or configured for different beamforming depending on the desired test conditions.

The test data source 340 may include hardware components and/or software components configured to generate a test payload (e.g., data packets) conforming to a reference test protocol or test case. The test data source 340 may output the test packets in the form of a test vector 342 including data bits.

The BB test equipment 350 is coupled to the test data source 340. The BB test equipment 350 may include hardware components and/or software components. The BB test equipment 350 is configured to generate a BB signal 352 from the test vector 342. In this regard, the BB test equipment 350 encodes the data bits in the test vector 342 according to a certain coding scheme and maps the encoded data bits to OFDM subcarriers (e.g., the subcarriers 204) according to a certain modulation order to produce a frequency domain test signal. The BB test equipment 350 generates a time-domain test signal 342 from frequency domain test signal, for example, by applying an inverse fast Fourier transform (IFFT) and appending each OFDM symbol (e.g., the symbols 206) with a cyclic prefix. In some instances, the BB test equipment 350 may also apply DFT spreading to prior to mapping the encoded data bits to the OFDM subcarriers. In some instances, the BB test equipment 350 may apply precoding to the BB signal 352 for beamforming. The BB test equipment 350 may configure the precoding based on precoding parameters specified for a certain test case. In some aspects, the BB test equipment 350 may perform similar operations as a BS such as the BSs 105.

The BB test equipment 350 is further configured to emulate various types of channel responses and/or noise based on channel parameters 332 and/or noise parameters 334. The channel responses may include doppler spread, doppler shift, delay spread, and/or any radio condition that an RF wave propagation may experience under an OTA operation. Similarly, the BB test equipment 350 may emulate noise, such as additive white Gaussian noise (AWGN), phase noise, and/or any noise impairments to create a certain signal-to-noise ratio (SNR) for testing. In some instances, the channel responses and/or noise may be specified by a conformance testing standard or specification. The channel responses may include desired channel characteristics in time, frequency, and/or spatial domains for the conformance tests. Similarly, the noise condition may include desired noise characteristics in time, frequency, and/or spatial domains for the conformance tests. The BB test equipment 350 is further configured to apply a certain channel response and/or noise to the BB signal 352 according to a certain test case.

The RF test equipment 360 is coupled to the BB test equipment 350. The RF test equipment 360 may include hardware components and/or software components configured to modulate the BB signal 352 to an RF signal 362. For instance, the RF test equipment 360 may include various RF components, such as mixers, power amplifiers, and/or antennas. The RF test equipment 360 is further configured to apply various RF parameters 336 to the RF signal generation. For instance, the RF parameters 336 may include an RF carrier frequency parameter, pathloss parameters, antenna relative phase parameters, and/or any parameter related to RF signal generation. The RF test equipment 360 is further configured to transmit the RF signal 362 via the test equipment antennas to the UE 315 under test.

In some aspects, a test procedure may be implemented by configuring the channel parameters 332, noise parameters 334, and/or RF parameters 336 according to a certain test case and configuring the BB test equipment 350 and the RF test equipment 360 to generate a RF test signal 362 based on the configured channel parameters 332, noise parameters 334, and/or RF parameters 336. The RF test equipment 360 transmits the RF test signal 362 via the test equipment antennas and the RF test signal 262 may be fed into the OTA chamber 370. The RF test signal 362 is received by the UE 315. The UE 315 may perform channel estimation and demodulation on the received signal 362. The UE 315 demodulation performance can be measured and reported for conformance testing.

One challenge in obtaining accurate performance measurement for demodulation testing using the test system 300 is that the OTA connection (between the RF test equipment 360 and the UE 315) can introduce additional channel characteristics (shown by the OTA channel 380) in addition to the desired channel (applied at the BB test equipment 350). For instance, the OTA channel 380 may produce quasi-static channel characteristics which may degrade demodulation performance.

For instance, the BB signal received at the UE 315 at a given subcarrier (e.g., the subcarriers 204) can be expressed as shown below:

Y=H_{undesired}×(H_{desired}×P×X+N), (1)

where X represents a BB test source vector (e.g., the test signal 342), H_{desired} represents the BB channel applied by the BB test equipment 350 (e.g., based on the channel parameters 332), P represents the precoding matrix applied by the BB test equipment 350, H_{undesired} represents the undesired channel (e.g., a quasi-static channel), and N represents the artificial noise added at the BB test equipment 350. The undesired channel H_{undesired} may correspond to the OTA channel 380, which may include channel characteristics introduced by the RF test equipment 360 (e.g., antennas), the OTA chamber 370, and/or the UE 315's RF frontend and/or insertion loss. During testing, the parameters X, H_{desired}, P, and N are given for a certain test case or test scenario.

As can be observed from Equation (1), the BB signal Y received at the UE 315 includes the undesired channel response H_{undesired} in addition to the desired channel response H_{desired} for the test case. Additionally, the OTA connection may produce different channel effects or channel characteristics between test equipment antenna and baseband of UE, which may depend on the relative angle between the antennas of the UE 315 and the test equipment antennas. In other words, H_{undesired} may vary depending on the relative angle between the UE 315's antennas and the test equipment antennas.

Accordingly, the present disclosure provides techniques to improve mmWave demodulation testing accuracy by pre-compensating or pre-equalizing the channel effects of the OTA connection in the RF test signal 362 at the test platform. Mechanisms for mmWave testing with OTA connection channel equalization are described in greater detail herein.

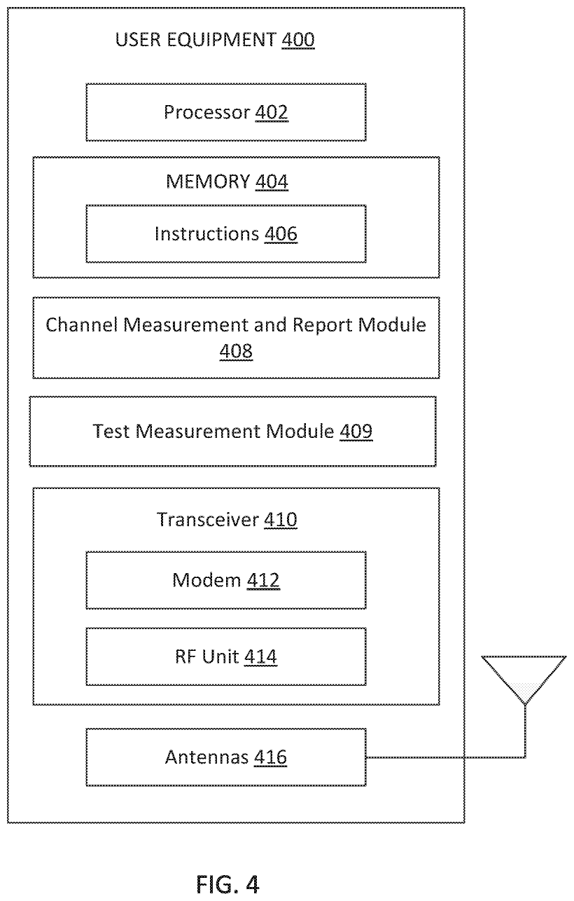

FIG. 4 is a block diagram of an exemplary UE 400 according to some aspects of the present disclosure. The UE 400 may be a UE 115 discussed above in FIG. 1 or a UE 315 discussed above in FIG. 3. As shown, the UE 400 may include a processor 402, a memory 404, a channel measurement and report module 408, a test measurement module 409, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

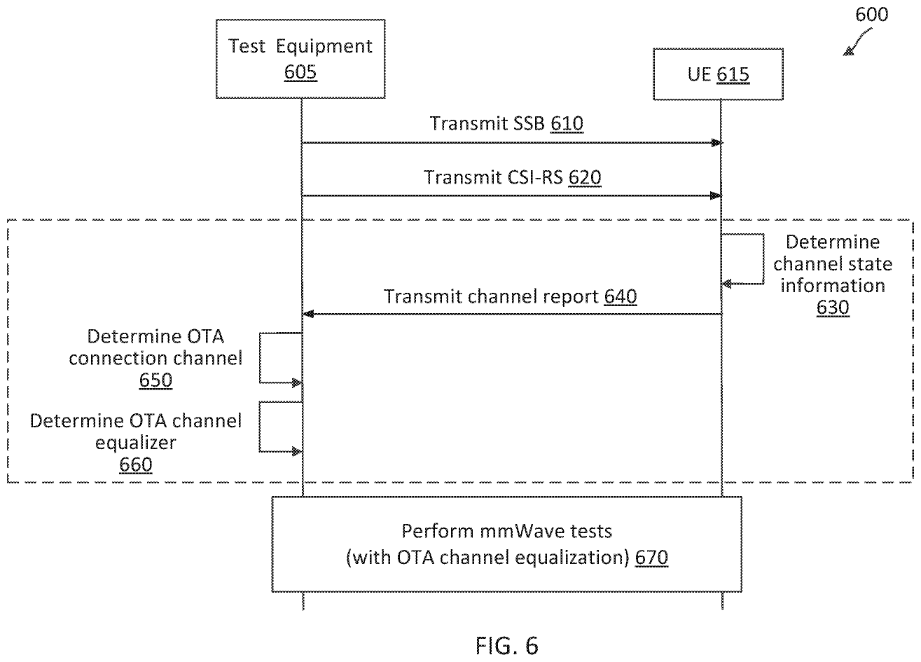

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs 115 in connection with aspects of the present disclosure, for example, aspects of FIGS. 3 and 6. Instructions 406 may also be referred to as program code. The program code may be for causing a wireless communication device to perform these operations, for example by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

Each of the channel measurement and report module 408 and the test measurement module 409 may be implemented via hardware, software, or combinations thereof. For example, each of the channel measurement and report module 408 and the test measurement module 409 may be implemented as a processor, circuit, and/or instructions 406 stored in the memory 404 and executed by the processor 402. In some examples, the channel measurement and report module 408 and the test measurement module 409 can be integrated within the modem subsystem 412. For example, the channel measurement and report module 408 and the test measurement module 409 can be implemented by a combination of software components (e.g., executed by a DSP or a general processor) and hardware components (e.g., logic gates and circuitry) within the modem subsystem 412. In some examples, a UE may include one or both of the channel measurement and report module 408 and the test measurement module 409. In other examples, a UE may include all of the channel measurement and report module 408 and the test measurement module 409.

The channel measurement and report module 408 and the test measurement module 409 may be used for various aspects of the present disclosure, for example, aspects of FIGS. 3 and 6. The channel measurement and report module 408 is configured to receive reference signals (e.g., SSBs, SSSs, CSI-RSs) from a BS (e.g., the BSs 115) or a test equipment (e.g., the BB test equipment 350 and the RF test equipment 360), compute RSRPBs and/or RSARPs based on the reference signals, and/or transmit channel state information including the RSRPBs and/or RSARPs to the BS or the test equipment. The RSRPBs and/or RSARPs can facilitate OTA channel equalization as described in greater detail herein.

The test measurement module 409 is configured to receive test signals from the test equipment, perform demodulation on the test signals, determine demodulation and/or decoding results (e.g., bit error rate or block error rate), and/or report the demodulation and/or decoding results to the test equipment.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404 and/or the channel measurement and report module 408 according to a modulation and coding scheme (MCS), e.g., a low-density parity check (LDPC) coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., PUSCH signals, PUCCH signals, channel state information, channel reports) from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 115 to enable the UE 115 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices. The antennas 416 may provide the received data messages for processing and/or demodulation at the transceiver 410. The transceiver 410 may provide the demodulated and decoded data (e.g., SSBs, synchronization signals, CSI-RSs, test signals) to the channel measurement and report module 408 for processing. The antennas 416 may include multiple antennas of similar or different designs in order to sustain multiple transmission links. The RF unit 414 may configure the antennas 416.

In an aspect, the UE 400 can include multiple transceivers 410 implementing different RATs (e.g., NR and LTE). In an aspect, the UE 400 can include a single transceiver 410 implementing multiple RATs (e.g., NR and LTE). In an aspect, the transceiver 410 can include various components, where different combinations of components can implement different RATs.

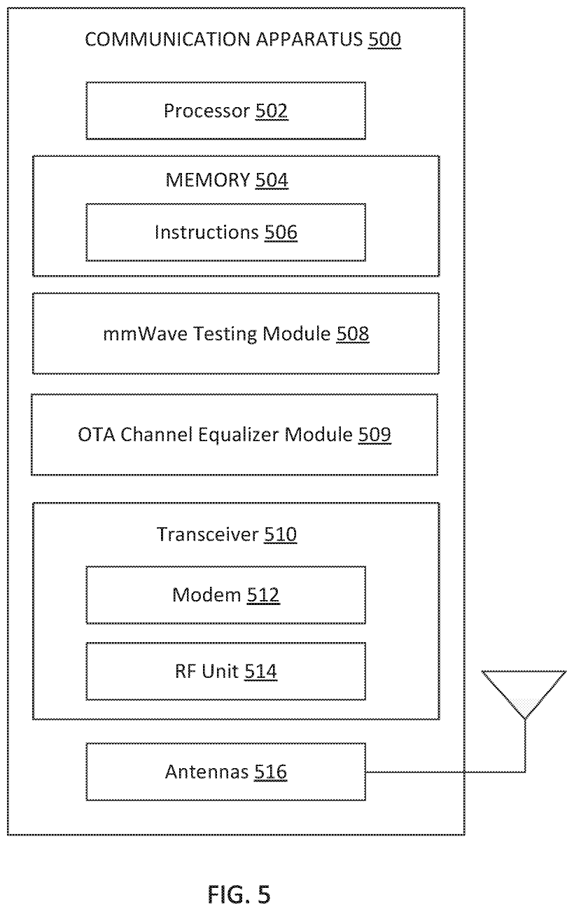

FIG. 5 is a block diagram of an exemplary a communication apparatus 500 according to some aspects of the present disclosure. In some instances, the communication apparatus 500 may be a BS 105 in the network 100 as discussed above in FIG. 1. In some other instances, the communication apparatus 500 may be a BB test equipment 350 of FIG. 3 or a RF test equipment 360 of FIG. 3. As shown, the communication apparatus 500 may include a processor 502, a memory 504, an OTA channel equalization module 509, a mmWave testing module 508, a transceiver 510 including a modem subsystem 512 and a RF unit 514, and one or more antennas 516. These elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 3 and 6-7. Instructions 506 may also be referred to as code, which may be interpreted broadly to include any type of computer-readable statement(s) as discussed above with respect to FIG. 4.

Each of the mmWave testing module 508 and the OTA channel equalization module 509 may be implemented via hardware, software, or combinations thereof. For example, each of the mmWave testing module 508 and the OTA channel equalization module 509 may be implemented as a processor, circuit, and/or instructions 506 stored in the memory 504 and executed by the processor 502. In some examples, the mmWave testing module 508 and the OTA channel equalization module 509 can be integrated within the modem subsystem 512. For example, the mmWave testing module 508 and the OTA channel equalization module 509 can be implemented by a combination of software components (e.g., executed by a DSP or a general processor) and hardware components (e.g., logic gates and circuitry) within the modem subsystem 512. In some examples, a UE may include one or both of the mmWave testing module 508 and the OTA channel equalization module 509. In other examples, a UE may include all of the mmWave testing module 508 and the OTA channel equalization module 509.

The mmWave testing module 508 and the OTA channel equalization module 509 may be used for various aspects of the present disclosure, for example, aspects of FIGS. 3 and 6. The mmWave testing module 508 is configured to transmit reference signals (e.g., SSBs, synchronization signals, and CSI-RSs) to a UE (e.g., the UEs 115, 315, and/or 400) positioned within an OTA chamber (e.g., the OTA chamber 370), receive channel state information (e.g., RSRPBs and RSARPs) from the UE, provide the channel state information to the OTA channel equalization module 509, and generate test signals for mmWave testing.

The OTA channel equalization module 509 is configured to determine a channel estimate for the OTA connection between the communication apparatus 500 the UE based on the channel state information, determine a channel equalizer for the OTA channel based on the channel estimate (e.g., for using zero forcing technique), and apply the OTA channel equalizer to the test signals prior to transmission to pre-compensate the test signals with an inverse of the OTA channel response. Mechanisms for OTA channel equalization in mmWave testing are described in greater detail herein.

As shown, the transceiver 510 may include the modem subsystem 512 and the RF unit 514. The transceiver 510 can be configured to communicate bi-directionally with other devices, such as the UEs 115 and/or 400 and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., SSBs, synchronization signals, CSI-RSs, test signals) from the modem subsystem 512 (on outbound transmissions) or of transmissions originating from another source such as a UE 115 and/or UE 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, e.g. data packets (or, more generally, data messages that may contain one or more data packets and other information), to the antennas 516 for transmission to one or more other devices. This may include, for example, transmission of information to complete attachment to a network and communication with a camped UE 115 or 400 according to some aspects of the present disclosure. The antennas 516 may further receive data messages transmitted from other devices and provide the received data messages for processing and/or demodulation at the transceiver 510. The transceiver 510 may provide the demodulated and decoded data (e.g., channel state information, RSRPBs, RSARPs) to the mmWave testing module 508 and OTA channel equalizer module 509 for processing. The antennas 516 may include multiple antennas of similar or different designs in order to sustain multiple transmission links.

In an example, the transceiver 510 is configured to transmit one or more reference signals to a UE located within an OTA chamber, receive channel state information from the UE in response to the one or more reference signals, for example, by coordinating with the mmWave testing module 508. The processor is configured to determine a channel estimate for the OTA connection between the communication apparatus 500 and the UE, for example, by coordinating with the mmWave testing module 508 and the OTA channel equalizer module 509. The transceiver 510 is configured to generate a test signal with pre-compensation based on the channel estimate of the OTA connection, for example, by coordinating with the mmWave testing module 508 and the OTA channel equalizer module 509.

In an aspect, the communication apparatus 500 can include multiple transceivers 510 implementing different RATs (e.g., NR and LTE). In an aspect, the communication apparatus 500 can include a single transceiver 510 implementing multiple RATs (e.g., NR and LTE). In an aspect, the transceiver 510 can include various components, where different combinations of components can implement different RATs.

FIG. 6 is a signaling diagram of a mmWave wireless communication device test method 600 according to some aspects of the present disclosure. The method 600 may be employed by the test system 300 to test wireless communication devices operating at mmWave frequencies. In particular, the method 600 may be implemented between a test equipment 605 and a UE 615. The test equipment 605 may be similar to the BB test equipment 350, the RF test equipment 360, and/or the communication apparatus 500. The UE 615 may be similar to the UEs 115, 315, and/or 400. The UE 615 may be placed within an OTA test chamber similar to the OTA chamber 370. Steps of the method 600 can be executed by computing devices (e.g., a processor, processing circuit, and/or other suitable component) of the test equipment 605 and the UE 615. As illustrated, the method 600 includes a number of enumerated steps, but embodiments of the method 600 may include additional steps before, after, and in between the enumerated steps. In some aspects, one or more of the enumerated steps may be omitted or performed in a different order.

At a high level, the test equipment 605 may transmit reference signals to the UE 615. The UE 615 may report channel information based on the reference signals. The test equipment 605 may perform similar operations as a BS (e.g., the BSs 105). For instance, the test equipment 605 may transmit SSBs and/or CSI-RSs to the UE 615, which may function as reference signals for channel measurements at the UE 615. The test equipment 605 may determine a channel response (e.g., the OTA channel 380) for the OTA connection based on the reported channel information and pre-equalize or pre-compensate test signals with an inverse response of the OTA channel estimate before transmitting the test signals to the UE 615.

At step 610, the test equipment 605 transmits SSBs to the UE 615. As discussed above, the SSBs may include PSS, SSS, and/or PBCH signals. In some aspects, the SSSs may be used by the UE 615 for channel measurements. The test equipment 605 may transmit the SSBs periodically. For instance, the test equipment 605 may utilize components, such as the transceiver 510, to transmit the SSBs according to a certain periodicity.

At step 620, the test equipment 605 transmits a CSI-RS to the UE 615. The test equipment 605 may transmit the CSI-RS periodically. For instance, the test equipment 605 may utilize components, such as the transceiver 510, to transmit the CSI-RS according to a certain periodicity. In some aspects, the test equipment 605 may transmit the SSSs or SSBs less frequent than the CSI-RSs. In other words, the SSBs or SSSs have a lower periodicity than the CSI-RSs. Additionally, the SSBs may occupy a smaller frequency bandwidth than the CSI-RSs. For instance, an SSB or SSS may occupy about 20 RBs (e.g., the RBs 210) at 15 kHz subcarrier spacing, whereas a CSI-RS may occupy an entire channel bandwidth or BWP used for communications between the test equipment 605 and the UE 615. In other words, SSSs or SSBs may have a lower time and/or frequency density than the CSI-RSs. Thus, CSI-RSs may allow for more accurate channel measurements.

At step 630, upon receiving the SSBs and the CSI-RSs, the UE 615 may determine channel state information based on the received SSBs and CSI-RSs. In this regard, the UE 615 may determine received signal power and/or relative phase information at antenna elements (e.g., the antennas 416) at the UE 615 based on synchronization signals in the SSBs and/or CSI-RSs. For instance, the UE 615 may utilize components, such as the processor 402, the channel measurement and report module 408, and the transceiver 410, to receive a signal carrying the SSB, receive a signal carrying a CSI-RS, determine a received signal power for the SSB, determine a received signal power for the CSI-RS, determine a relative phase between signals received from a first antenna element and a second antenna element at the UE 615.

In some aspects, the UE 615 may determine an RSRPB and/or RSARP from the synchronization signals (e.g., the SSSs) in the SSBs and/or CSI-RSs. RSRPB may refer to receive signal power per branch. For instance, mmWave transmissions may have two polarizations. The two polarizations be orthogonal to each other. However, in practice, there may be leakage between the two polarizations. The UE 615 may compute a received signal power for an SSS at one polarization and another received signal power for the SSS at another polarization. Similarly, the UE 615 may compute a received signal power for a CSI-RS at one polarization and another received signal power for the CSI-RS at another polarization. RSARP may refer to a phase difference between a reference antenna port and another antenna port at the UE 615. For instance, the UE 615 may receive an SSS at an antenna port 0 and an antenna port 1. In some instances, the antenna port 0 and the antenna port 1 may each correspond to one of the polarizations. The UE 615 may determine a phase difference between the SSS received at the antenna port 0 and the SSS received at the antenna port 1. Similarly, the UE 615 may receive a CSI-RS at an antenna port 0 and an antenna port 1 and determine a phase difference between the CSI-RS received at the antenna port 0 and the CSI-RS received at the antenna port 1.

At step 640, the UE 615 transmits a channel report to the test equipment 605 based on the channel measurements. In some instances, the channel report may include RSRPBs determined based on SSSs, RSARPs determined based on the SSSs, RSRPBs determined based on the CSI-RSs, RSARPs determined based on the CSI-RSs, or any combination thereof. For instance, the UE 615 may utilize components, such as the processor 402, the channel measurement and report module 408, and/or the transceiver 410, to transmit the channel report.

At step 650, upon receiving the channel report, the test equipment 605 may determine a channel estimate for the OTA connection based on the received channel reports. In this regard, the test equipment 605 may construct a channel matrix representing the OTA channel from amplitude information determined from the received RSRPBs and phase information determined from the received RSARPs.

Referring to the system 300 of FIG. 3 and Equation (1) discussed above, the test equipment 605 may construct an OTA channel matrix H undesired from the received RSRPBs and RSARPs. As an example, the test equipment 605 may have two transmit antennas (e.g., a first transmit antenna Tx0 and a second transmit antenna Tx1) and the UE 615 may have two receive antennas (e.g., a first receive antenna Rx0 and a second receive antenna Rx1). The test equipment 605 may transmit a reference signal using a first polarization via the first transmit antenna Tx0 and using a second polarization via the second transmit antenna Tx1. For each polarization, the UE 615 may compute a receive signal power of the reference signal at the first receive antenna Rx0 and a receive signal power of the reference signal at the second receive antenna Rx1. Thus, with two polarizations, the UE 615 may compute and report four RSRPBs. For instance, the four RSRPBs may include a receive signal power measured at the UE antenna Rx0 based transmission from the test equipment antenna Tx0 (denoted as a reception Tx0Rx0), a receive signal power measured at the UE antenna Rx1 based transmission from the test equipment antenna Tx0 (denoted as a reception Tx0Rx1), a receive signal power measured at the UE antenna Rx0 based transmission from the test equipment antenna Tx1 (denoted as a reception Tx1Rx0), and a receive signal power measured at the UE antenna Rx1 based transmission from the test equipment antenna Tx1 (denoted as a reception Tx1Rx1). The test equipment 605 may construct the amplitude portion of H_{undesired} based on the RSPRBs. Similarly, for each polarization, the UE 615 may compute relative phase between the first receive antenna and the second antenna. Thus, with two polarizations, the UE 615 may compute and report two RSARPs. For instance, the RSARPs may include a relative phase between Tx0Rx0 and Tx0Rx1 and a relative phase between Tx1Rx0 and Tx1Rx1. The test equipment 605 may construct the phase portion of H_{Chamber} based on the RSARPs. In some instances, the test equipment 605 may utilize components, such as the processor 502, the mmWave testing module 508, the OTA channel equalizer module 509, and the transceiver 510, to construct the OTA channel estimate H_{undesired} based on the UE 615's reported RSRPBs and/or RSARPs as discussed.

At step 660, after determining the OTA channel response or H_{undesired}, the test equipment 605 may determine an OTA channel equalizer based on H_{undesired}. For instance, the test equipment 605 may apply a zero forcing (ZF) approach to determine a pseudo channel equalizer matrix as expressed below:

H_{undesired}⁺=(H_{undersired}^{H}×H_{undesired}^{H})⁻¹×H_{undesired}^{H}, (2)

where H_{undesired}⁺ represents the pseudo channel equalizer matrix and H_{undesired}^{H} represents the Hermitian form of H_{undesired}. In some instances, the test equipment 605 may utilize components, such as the processor 502, the mmWave testing module 508, the OTA channel equalizer module 509, and the transceiver 510, to determine the OTA channel equalizer as shown in Equation (2).

At step 670, the test equipment 605 may perform mmWave testing on the UE 615 by generating test signals with OTA channel pre-equalization as shown below:

$${Y}^{′} = {H}_{undesired}^{+} \times {H}_{undesired} \times ( {H}_{desired} \times P \times X + N ) = {H}_{desired} \times P \times X + N ,$$

where Y′ represents the signal received at the UE 615 after the pre-equalization. As can be observed from Equation (3), the UE 615 may receive a test signal with the desired channel H_{desired} and without the undesirable OTA channel H_{undesired}. For instance, the test equipment 605 may utilize components, such as the processor 502, the mmWave testing module 508, the OTA channel equalizer module 509, and the transceiver 510, to generate the test signal with OTA channel equalization as shown in Equation (3).

Subsequently, the UE 615 may determine test results based on the test signals. The UE 615 may report the test results to the test equipment 605. Alternatively, the test equipment 605 may query the UE 615 for test results.

In some aspects, the steps 630-660 (shown by the dashed box) may be repeated, for example, at a period greater than the repeating period (e.g., a period of T) of the SSB transmission and/or the repeating period of CSI-RS. In other words, the UE 615 may transmit updated RSRPBs and/or RSARPs based on another reception of SSSs and/or CSI-RSs and the test equipment 605 may recompute or update the equalizer H_{undesired}⁺ based on the updated RSRPBs and/or RSARPs.

In some aspects, the steps 630-660 may be repeated when a relative direction between the test equipment 605 and the UE 615 changes. For instance, the UE 615 may be repositioned within the OTA chamber such that that transmission to the test equipment 605 and/or reception from the test equipment 605 is changed to a different angle. As discussed above, the OTA channel may change based on a relative angle or direction between the test equipment 605 and the UE 615. Thus, the steps 630-660 may be repeated so that the test equipment 605 may update the equalizer H_{undesired}⁺ for the updated channel before proceeding with testing.

While the method 600 is described in the context of testing the UE 615 receiver, similar mechanisms may be applied to the testing of the test equipment 605 receiver. For instance, the test equipment 605 may apply a similar OTA channel equalizer to a signal received from the UE to post-compensate the OTA channel.

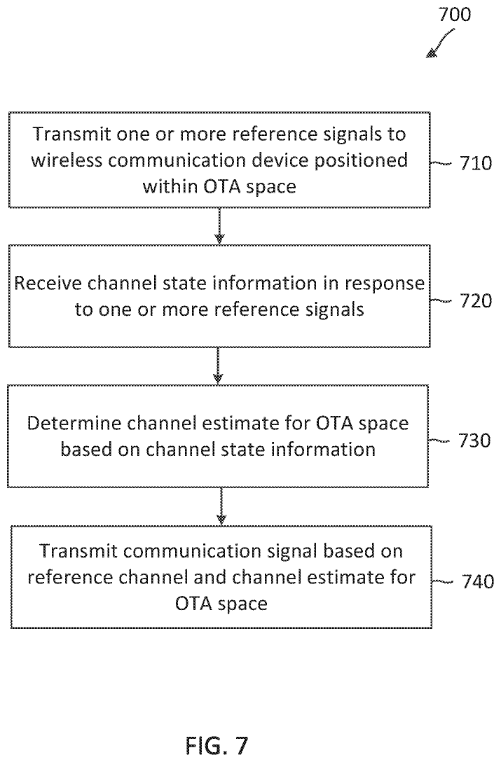

FIG. 7 is a flow diagram of a mmWave wireless communication device test method 700 according to some aspects of the present disclosure. Steps of the method 700 can be executed by a computing device (e.g., a processor, processing circuit, and/or other suitable component) of an apparatus or other suitable means for performing the steps. For example, an apparatus, such as the communication apparatus 500, the test equipment 350 and/or 615, may utilize one or more components, such as the processor 502, the memory 504, the OTA channel equalizer module 509, the transceiver 510, the modem 512, and the one or more antennas 516, to execute the steps of method 700. The method 700 may employ similar mechanisms as in the method 600 described above with respect to FIG. 6, respectively. As illustrated, the method 700 includes a number of enumerated steps, but aspects of the method 700 may include additional steps before, after, and in between the enumerated steps. In some aspects, one or more of the enumerated steps may be omitted or performed in a different order.

At block 710, the apparatus transmits, to a wireless communication device positioned within an OTA space, one or more reference signals. The wireless communication device may correspond to a UE similar to the UEs 115, 315, and/or 615. For instance, the apparatus may utilize components, such as the processor 502, the mmWave testing module 508, the OTA channel equalizer module 509, and the transceiver 510, to transmit one or more reference signals to the wireless communication device positioned within the OTA space.

At block 720, the apparatus receives, from the wireless communication device, channel state information in response to the one or more reference signals. For instance, the apparatus may utilize components, such as the processor 502, the mmWave testing module 508, the OTA channel equalizer module 509, and the transceiver 510, to receive the channel state information from the wireless communication device in response to the one or more reference signals.

At block 730, the apparatus determines a channel estimate (e.g., H undesired) for the OTA space based on the received channel state information. For instance, the apparatus may utilize components, such as the processor 502, the mmWave testing module 508, the OTA channel equalizer module 509, and the transceiver 510, to determine the channel estimate for the OTA space based on the received channel state information.

At block 740, the apparatus transmits, to the wireless communication device, a communication signal based on a reference channel (e.g., H_{desired}) and the channel estimate for the OTA space. For instance, the apparatus may utilize components, such as the processor 502, the mmWave testing module 508, the OTA channel equalizer module 509, and the transceiver 510, to transmit the communication signal to the wireless communication device based on the reference channel and the channel estimate for the OTA space.

In some aspects, the channel state information includes at least one of a received signal power measurement based on a reference polarization or relative phase information between two antenna elements at the wireless communication device. In some aspects, the channel state information includes a RSRPB, a RSARP, or any combination thereof.

In some aspects, the one or more reference signals include a synchronization signal (e.g., an SSS), a CSI-RS, or any combination thereof. In some aspects, the one or more reference signals include a CSI-RS and the channel state information includes least one of a RSRPB or a RSARP measured from the CSI-RS. In some aspects, the apparatus transmits the one or more reference in a mmWave band.

In some aspects, the apparatus further determines a ZF equalizer based on the channel estimate for the OTA space, for example, as shown in Equation (2) above.

In some aspects, the OTA space includes an OTA test chamber similar to the OTA chamber 370 and the channel state information includes channel characteristics associated with the OTA chamber and a frontend (e.g., the RF unit 414) of the wireless communication device.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication, comprising:
transmitting, by an apparatus to a wireless communication device positioned within an over-the-air (OTA) space, one or more reference signals;
receiving, by the apparatus from the wireless communication device, channel state information in response to the one or more reference signals;
determining, by the apparatus, a channel estimate for the OTA space based on the received channel state information; and
transmitting, by the apparatus to the wireless communication device, a communication signal based on a reference channel and the channel estimate for the OTA space.

2. The method of claim 1, wherein the receiving includes:
receiving, by the apparatus from the wireless communication device, at least one of a received signal power measurement based on a reference polarization or relative phase information between two antenna elements at the wireless communication device.

3. The method of claim 2, wherein the receiving includes:
receiving, by the apparatus from the wireless communication device, a reference signal received power per branch (RSRPB) report including the received signal power measurement.

4. The method of claim 2, wherein the receiving includes:
receiving, by the apparatus from the wireless communication device, a reference signal antenna relative phase (RSARP) report including the relative phase information.

5. The method of claim 1, wherein the transmitting includes:
transmitting, by the apparatus to the wireless communication device, a synchronization signal.

6. The method of claim 1, wherein the transmitting includes:
transmitting, by the apparatus to the wireless communication device, a channel state information-reference signal (CSI-RS);
and wherein the receiving includes:
receiving, by the apparatus from the wireless communication device, at least one of a reference signal antenna relative phase (RSARP) report based on the transmitted CSI-RS or a reference signal antenna relative phase (RSARP) report based on the transmitted CSI-RS.

7. (canceled)

8. The method of claim 1, wherein the transmitting includes:
transmitting, by the apparatus to the wireless communication device, the one or more reference signals in a millimeter wave (mmWave) band.

9. The method of claim 1, further comprising:
determining, by the apparatus, a zero forcing (ZF) equalizer based on the channel estimate for the OTA space; and
generating, by the apparatus, the communication signal based on the reference channel and the ZF equalizer.

10. (canceled)

11. The method of claim 1, wherein the channel state information includes a channel characteristic associated with a frontend of the wireless communication device.

12. An apparatus comprising:
a transceiver configured to:
transmit, to a wireless communication device positioned within an over-the-air (OTA) space, one or more reference signals;
receive, from the wireless communication device, channel state information in response to the one or more reference signals; and
transmit, to the wireless communication device, a communication signal based on a reference channel and a channel estimate for the OTA space; and
a processor configured to:
determine the channel estimate for the OTA space based on the received channel state information.

13. The apparatus of claim 12, wherein the transceiver configured to receive the channel state information is configured to:
receive, from the wireless communication device, at least one of a received signal power measurement based on a reference polarization or relative phase information between two antenna elements at the wireless communication device.

14. The apparatus of claim 13, wherein the transceiver configured to receive the channel state information is configured to:
receive, from the wireless communication device, a reference signal received power per branch (RSRPB) report including the received signal power measurement.

15. The apparatus of claim 13, wherein the transceiver configured to receive the channel state information is configured to:
receive, by the apparatus from the wireless communication device, a reference signal antenna relative phase (RSARP) report including the relative phase information.

16. The apparatus of claim 12, wherein the transceiver configured to transmit the one or more reference signal is configured to:
transmit, to the wireless communication device, a synchronization signal.

17. The apparatus of claim 12, wherein the transceiver configured to transmit the one or more reference signal is configured to:
transmit, to the wireless communication device, a channel state information-reference signal (CSI-RS); and
wherein the transceiver configured to receive the channel state information is configured to:
receive, from the wireless communication device, at least one of a reference signal antenna relative phase (RSARP) report based on the transmitted CSI-RS or a reference signal antenna relative phase (RSARP) report based on the transmitted CSI-RS.

18. (canceled)

19. The apparatus of claim 12, wherein the transceiver configured to transmit the one or more reference signal is configured to:
transmit, to the wireless communication device, the one or more reference signals in a millimeter wave (mmWave) band.

20. The apparatus of claim 12, wherein the processor is further configured to:
determine a zero forcing (ZF) equalizer based on the channel estimate for the OTA space; and
generate the communication signal based on the reference channel and the ZF equalizer.

21. (canceled)

22. The apparatus of claim 12, wherein the channel state information includes a channel characteristic associated with a frontend of the wireless communication device.

23. A non-transitory computer-readable medium having program code recorded thereon, the program code comprising:
code for causing an apparatus to transmit, to a wireless communication device positioned within an over-the-air (OTA) space, one or more reference signals;
code for causing the apparatus to receive, from the wireless communication device, channel state information in response to the one or more reference signals; and
code for causing the apparatus to determine a channel estimate for the OTA space based on the received channel state information; and
code for causing the apparatus to transmit, to the wireless communication device, a communication signal based on a reference channel and the channel estimate for the OTA space.

24. The non-transitory computer-readable medium of claim 23, wherein the code for causing the apparatus to receive the channel state information is configured to:
receive, from the wireless communication device, at least one of a received signal power measurement based on a reference polarization or relative phase information between two antenna elements at the wireless communication device.

25. The non-transitory computer-readable medium of claim 24, wherein the code for causing the apparatus to receive the channel state information is configured to:
receive, from the wireless communication device, a reference signal received power per branch (RSRPB) report including the received signal power measurement.

26. The non-transitory computer-readable medium of claim 24, wherein the code for causing the apparatus to receive the channel state information is configured to:
receive, by the apparatus from the wireless communication device, a reference signal antenna relative phase (RSARP) report including the relative phase information.

27. The non-transitory computer-readable medium of claim 23, wherein the code for causing the apparatus to transmit the one or more reference signal is configured to:
transmit, to the wireless communication device, a synchronization signal.

28. The non-transitory computer-readable medium of claim 23,
wherein the code for causing the apparatus to transmit the one or more reference signal is configured to:
transmit, to the wireless communication device, a channel state information-reference signal (CSI-RS); and
wherein the code for causing the apparatus to receive the channel state information is configured to:
receive, from the wireless communication device, at least one of a reference signal antenna relative phase (RSARP) report based on the transmitted CSI-RS or a reference signal antenna relative phase (RSARP) report based on the transmitted CSI-RS.

29. (canceled)

30. The non-transitory computer-readable medium of claim 23, wherein the code for causing the apparatus to transmit the one or more reference signal is configured to:
transmit, to the wireless communication device, the one or more reference signals in a millimeter wave (mmWave) band.

31. The non-transitory computer-readable medium of claim 23, further comprising:
code for causing the apparatus to determine a zero forcing (ZF) equalizer based on the channel estimate for the OTA space; and
code for causing the apparatus to generate the communication signal based on the reference channel and the ZF equalizer.

32. (canceled)

33. The non-transitory computer-readable medium of claim 23, wherein the channel state information includes a channel characteristic associated with a frontend of the wireless communication device.

34. An apparatus comprising:
means for transmitting, to a wireless communication device positioned within an over-the-air (OTA) space, one or more reference signals;
means for receiving, from the wireless communication device, channel state information in response to the one or more reference signals; and
means for determining a channel estimate for the OTA space based on the received channel state information; and
means for transmitting, to the wireless communication device, a communication signal based on a reference channel and the channel estimate for the OTA space.

35. The apparatus of claim 34, wherein the means for receiving the channel state information is configured to:
receive, from the wireless communication device, at least one of a received signal power measurement based on a reference polarization or relative phase information between two antenna elements at the wireless communication device.

36. The apparatus of claim 35, wherein the means for receiving the channel state information is configured to:
receive, from the wireless communication device, a reference signal received power per branch (RSRPB) report including the received signal power measurement.

37. The apparatus of claim 35, wherein the means for receiving the channel state information is configured to:
receive, by the apparatus from the wireless communication device, a reference signal antenna relative phase (RSARP) report including the relative phase information.

38. The apparatus of claim 34, wherein the means for transmitting the one or more reference signal is configured to:
transmit, to the wireless communication device, a synchronization signal.

39. The apparatus of claim 34, wherein the means for transmitting the one or more reference signal is configured to:
transmit, to the wireless communication device, a channel state information-reference signal (CSI-RS); and
wherein the means for receiving the channel state information is configured to
receive, from the wireless communication device, at least one of a reference signal antenna relative phase (RSARP) report based on the transmitted CSI-RS or a reference signal antenna relative phase (RSARP) report based on the transmitted CSI-RS.

40. (canceled)

41. The apparatus of claim 34, wherein the means for transmitting the one or more reference signal is configured to:
transmit, to the wireless communication device, the one or more reference signals in a millimeter wave (mmWave) band.

42. The apparatus of claim 34, further comprising:
means for determining a zero forcing (ZF) equalizer based on the channel estimate for the OTA space; and
means for generating the communication signal based on the reference channel and the ZF equalizer.

43-44. (canceled)
